(19) United States
(12) Patent Application Publication
(10) Pub. No.: US 2010/0166374 A1
(43) Pub. Date: Jul. 1, 2010

(54) CABLE

(75) Inventor: Siegbert Lapp, Stuttgart (DE)

Correspondence Address: Lipsitz & McAllister, LLC, 755 MAIN STREET, MONROE, CT, 06468, US

(73) Assignee: Lapp Engineering & Co., Cham (CH)

(21) Appl. No.: 12/587,410

(22) Filed: Oct. 5, 2009

Related U.S. Application Data
(63) Continuation of application No. PCT/EP2008/002604, filed on Apr. 2, 2008.

(30) Foreign Application Priority Data
Apr. 10, 2007 (DE) 10 2007 017 964.4

(51) Int. Cl. G02B 6/44; H02G 3/00

(52) U.S. Cl. 385/101; 174/70 R

(57) ABSTRACT

In order to improve a cable that comprises an inner cable body, in which at least one conductor strand of an optical and/or electrical conductor runs in the longitudinal direction of the cable, a cable sheath, enclosing the inner cable body and lying between an outer surface of the cable and the inner cable body, and at least one information carrier unit, disposed within the outer surface of the cable, in such a way that, while being easy to produce, the information carrier unit is reliably disposed at suitable points in the cable, it is proposed that a carrier strand is associated with the inner cable body, the carrier strand running over the length of the inner cable body, that at least one information carrier unit that can be read by electromagnetic field coupling is disposed on the carrier strand and that the carrier strand is covered over by the cable sheath.

This application is a continuation of International application No. PCT/EP 2008/002604 filed on Apr. 2, 2008.

This patent application claims the benefit of International application No. PCT/EP 2008/002604 of Apr. 2, 2008 and German application No. 10 2007 017 964.4 of Apr. 10, 2007, the teachings and disclosure of which are hereby incorporated in their entirety by reference thereto.

The invention relates to a cable, comprising an inner cable body, in which at least one conductor strand of an optical and/or electrical conductor runs in the longitudinal direction of the cable, a cable sheath, enclosing the inner cable body and lying between an outer surface of the cable and the inner cable body, and at least one information carrier unit, disposed within the outer surface of the cable.

Cables with an information carrier unit are known from the prior art. However, in the case of the known solutions it is not specifically stated how the information carrier unit can be disposed in the cable to allow the cable to be produced optimally in terms of process technology and at low cost and on the other hand to allow suitable points for the information carrier unit to be fixed.

It is therefore an object of the invention to improve a cable of the generic type with regard to its structure in such a way that, while being easy to produce, the information carrier unit is reliably disposed at suitable points in the cable.

This object is achieved according to the invention in the case of a cable of the type described at the beginning by a carrier strand being associated with the inner cable body, the carrier strand running over the length of the inner cable body, by at least one information carrier unit that can be read by electromagnetic field coupling being disposed on the carrier strand and by the carrier strand being covered over by the cable sheath.

The advantage of the solution according to the invention can be seen in that the carrier strand provides an optimum possible way of positioning the information carrier unit optimally in the cable, and consequently also allows, in particular, low-cost, easy production of the cable.

Furthermore, the solution according to the invention also provides a possible way of improving the ease with which the information carrier unit can be read and located by way of the defined positioning of said information carrier unit, since the solution according to the invention has provided a possible way of disposing the information carrier unit in a defined manner that also allows information carrier units to be used that can, for example, be read over short ranges.

The statement that the information carrier unit is intended to be readable by electromagnetic field coupling is to be understood here as meaning that the reading of the information carrier unit is intended to be possible not only in the LF range but also in the HF range or in the UHF range.

With regard to the way in which the carrier strand is disposed in the cable, no further details have been specified so far.

An exemplary embodiment provides that the carrier strand runs parallel to a longitudinal direction of the inner cable body. This means that the carrier strand runs, for example, along the inner cable body over the entire length of the same.

For example, this can be easily realized by the carrier strand being formed as a filler tape which, during the production of the cable, is fed to the inner cable body that is possibly provided with a separating layer, lies against said body and is then covered over by the cable sheath produced by extrusion.

As an alternative to the carrier strand running parallel to a longitudinal direction of the inner cable body, another exemplary embodiment provides that the carrier strand runs such that it wraps around the at least one conductor strand of the inner cable body.

A wrapping-around run of this kind can be realized in a wide variety of ways.

An advantageous solution provides that the carrier strand is formed such that it winds around the inner cable body, and consequently spirally surrounds the inner cable body, it being possible in this case for the alignment of the carrier strand to be entirely independent of a twisting direction of the conductor strand.

It is therefore conceivable for the carrier strand to run approximately in the same direction as, or in the opposite direction to, a twisting direction of the conductor strands.

If it runs approximately parallel to and in the same direction as the conductor strand, the carrier strand can, for example, be twisted along with said conductor strand during the production of the cable.

In this case, the carrier strand may be a carrier strand that is independent of the inner cable body.

The carrier strand may, however, also be formed as part of the inner cable body, that is for example when the carrier strand runs in the form of an interstitial cord of the inner cable body.

Furthermore, the carrier strand may be disposed in various ways in relation to the inner cable body in connection with realizing the solution according to the invention.

For example, it is conceivable for the carrier strand to lie directly on the inner cable body.

However, it is also conceivable for the carrier strand to be at least part of a separating layer between the inner cable body and the cable sheath.

In the case of all forms of the carrier strand, it is of advantage if, for example in the case of flexible cables, the carrier strand does not cause any disturbance of the mechanical conditions in the cable.

For this reason, it is preferably provided in the case of an exemplary embodiment that the carrier strand acts symmetrically neutral in the cable. This means that no disturbance of the mechanical symmetry of the forces occurring during bending of the cable occurs, which would be the case, for example, if bending of the cable were made more difficult or easier in one direction than in other directions by virtue of the carrier strand.

A solution in which the carrier strand encloses the inner cable body substantially over its complete area is advantageous. In the case of this solution, the mechanical conditions in the cable can be easily maintained undisturbed.

Particularly advantageous is a solution in which the carrier strand completely encloses the inner body of the cable, and consequently also forms, for example, the separating layer.

A further possibility provides that the carrier strand lies on a separating layer between the inner cable body and the cable sheath.

Furthermore, the information carrier unit may still be disposed in various ways in relation to the carrier strand.

One possible way of disposing the information carrier unit is that the information carrier unit is disposed on a side of the carrier strand that is facing the inner cable body.

For example, this is conceivable when either the information carrier unit lies directly on the inner cable body or the carrier strand lies on the separating layer, so that the information carrier unit is then disposed between the carrier strand and the separating layer.

Another possibility is that the information carrier unit is disposed on a side of the carrier strand that is facing away from the inner cable body.

In the case of this solution, it is conceivable, for example, to place the carrier strand directly on the inner cable body, so that the information carrier unit can then, for example, be covered over by the separating layer.

However, it is also conceivable for the information carrier unit to be covered over directly by the cable sheath.

A further possibility provides that the information carrier unit is embedded in the carrier strand. This is the case, in particular, when the carrier strand runs in the form of an interstitial cord in the inner cable body.

Particularly advantageous is a disposition in which the information carrier unit is disposed such that no disturbance of the relative movement of the separating layer and the inner cable body occurs, in particular as a result of changed friction between them, in order in the case of flexible and highly flexible cables to avoid, for example, the development of torsion of the inner cable body and the cable sheath.

This can be realized, for example, by the information carrier unit lying on the inner cable body with a side that does not hinder sliding on the inner cable body, or by the carrier strand itself lying on the inner cable body with a side that does not hinder sliding on the inner cable body, and the information carrier unit lying on the side of the carrier strand that is facing away from the inner cable body.

With regard to the forming of the information carrier unit itself, no further details have been specified so far.

An advantageous embodiment provides that the information carrier unit comprises a base.

In this case, it is provided that an integrated circuit of the information carrier unit is disposed on the base.

Furthermore, it is suitably provided in this case that a conductor acting as an antenna is disposed on the base.

The antenna may in this case be produced from conductor tracks, produced by a lacquer applied to the base. Particularly advantageous is an embodiment in which the antenna is applied to the base by a printing operation.

For example, it is conceivable in the case of one embodiment for the base to be a rigid body.

The base may, for example, be a plate or at least part of an embedding body in which the integrated circuit and the conductor for the antenna are at least partially embedded.

Consequently, the base is, for example, at least part of an embedding body enclosing the integrated circuit and the antenna.

The embedding body may, for example, have the form of a lens, a half-lens or a cylinder.

As an alternative to this, it is provided that the base is made of a flexible material.

A flexible material of this kind could be, for example, a resiliently flexible material.

It is particularly advantageous, however, for introducing the information carrier units with the base into the cable, if the flexible material is a so-called pliant material.

In order furthermore, however, to avoid damage to the integrated circuit and the conductor forming the antenna, and in particular also the terminals between the integrated circuit and the conductor forming the antenna, it is preferably provided that the flexible material is resistant to tension in at least one direction.

With regard to the connection of a base of this kind to the carrier strand, likewise no further details have been specified so far. An advantageous solution provides that the base is fixed to the carrier strand.

For example, it is provided in this case that the base is fixed to the carrier strand by way of at least one connecting point.

A solution of this kind does not in this case require full-area bonding of the base to the carrier strand, but rather it is adequate, for example, for the base to be bonded to the carrier strand partially or in certain portions.

In particular, it is advantageous in this respect if the at least one connecting point is an adhesive point.

As an alternative to this, it is conceivable for the carrier strand to form a portion of the base.

This is the case, for example, when the carrier strand is an interstitial cord in which the integrated circuit and the conductor for the antenna are embedded.

However, it is also conceivable to produce the entire carrier strand from a material that is suitable as a base for the information carrier unit, for example from a pliant strip material.

With regard to the number of information carrier units, no further details have been specified so far.

An, advantageous embodiment provides that one information carrier unit is prescribed for each cable. This has the disadvantage, however, that there is then the problem of using the read device to find an information carrier unit of the cable in order to read out the information stored in the unit.

For this reason, it is advantageously provided that a multiplicity of information carrier units are disposed on the carrier strand.

The multiplicity of information carrier units could in principle be disposed at any desired intervals on the carrier strand.

In order to make it possible for the information carrier units to be reliably found, it is preferably provided that the information carrier units are disposed at defined regular intervals in the longitudinal direction of the cable.

The defined regular intervals could also specify variable distances, for example smaller distances at the ends of the cable that increase toward the middle.

In the simplest case, however, it is suitable if the defined regular intervals for the information carrier units determine a uniform distance between the information carrier units in the longitudinal direction of the cable.

Furthermore, the information carrier units have, in the longitudinal direction of the cable, a reading/writing range, which depends on the frequency at which they are operated and also how the antenna is formed.

In order to avoid multiple reading out by multiple information carrier units, and consequently misinterpretation of the data read-out when the information carrier units are addressed by the read device, it is preferably provided that the information carrier units are disposed at the defined regular intervals in relation to one another in such a way that the distances between the information carrier units correspond to at least 2 times a reading/writing range of the information carrier units in the direction of each of the nearest information carrier units.

It is still better if the distances correspond at least to at least 2.5 times the reading/writing range of the information carrier units in the direction of the nearest information carrier unit.

With regard to the structure of the information carrier units, no further details have been specified so far.

An advantageous solution provides that the information carrier unit has at least one memory for the information that can be read out.

Such a memory could be formed in a wide variety of ways. For example, the memory could be formed such that the information stored in it can be overwritten by the read device.

However, a particularly advantageous solution provides that the memory has a memory area in which items of information once written are stored such that they are write-protected.

Such a memory area is suitable, for example, for storing an identification code for the information carrier unit or other data specific to this information carrier unit, which can no longer be changed by any of the users.

Such a memory area is also suitable, however, for the cable manufacturer to store information which is not to be overwritten. Such information is, for example, cable data, cable specifications or else details of the type of cable and how it can be used.

However, these data may, for example, also be supplemented by data comprising details about the manufacture of this specific cable or data representing test records from final testing of the cable.

In addition, a memory according to the invention may also be formed furthermore in such a way that it has a memory area in which items of information are stored such that they are write-protected by an access code.

Such write-protected storage of information may, for example, comprise data which can be stored by a user. For example, after preparation of the cable, a user could store in the memory area data concerning the preparation of the cable or concerning the overall length of the cable or concerning the respective portions over the length of the cable, the user being provided with an access code by the cable manufacturer for this purpose, in order to store these data in the memory area.

A further advantageous embodiment provides that the memory has a memory area to which information can be freely written.

Such a memory area may, for example, receive information which is to be stored by the cable user in the cable, for example concerning the type of installation or the preparation of the same.

In particular when a number of information carrier units are used, it would be conceivable, for example, for it to be possible for all the information carrier units to be addressed with one access code. However, this has the disadvantage that the information carrier units consequently cannot be selectively used, for example to assign different information to specific portions of the cable.

One conceivable solution for assigning different information to different portions of the cable would be that each of the information carrier units bears a different specified length, so that, by reading out the specified length of an information carrier unit, its distance from one of the ends of the cable or from both ends of the cable can be determined.

For this reason, it is advantageous if each of the information carrier units can be individually addressed by an access code.

In connection with the description so far of the information carrier units, it has just been assumed that they carry information which has been stored in the information carrier units by external read/write devices either before or during the production of the cable or during the use of the cable.

A further advantageous solution for a cable according to the invention provides that the at least one information carrier unit of the cable picks up measured values of an associated sensor, that is to say that the information carrier unit not only stores and makes available external information but is itself capable of acquiring information about the cable, that is to say physical state variables of the cable.

For example, it is provided that the sensor picks up at least one of the state variables such as physical radiation, temperature, tension, pressure, elongation or moisture.

A particularly advantageous solution provides that shear stresses in the cable can be picked up by the sensor.

With regard to the operation of the information carrier unit and the operation of the sensor by the information carrier unit, no further details have been specified so far. An advantageous solution provides that the information carrier unit reads out the sensor in the activated state.

This means that the information carrier unit has no power supply of its own, but has to be activated by an external energy supply.

One possibility for such activation is that the information carrier unit can be activated by a read device.

Another advantageous solution provides that the information carrier unit can be activated by an electromagnetic field of a current flowing through the cable.

An electromagnetic field of this kind can be achieved for example by a current for supplying power to items of equipment that flows through the cable and builds up the electromagnetic field.

However, it is also conceivable to provide in the cable dedicated conductor strands which produce an electromagnetic field for supplying energy to the at least one information carrier unit or the multiplicity of information carrier units.

With regard to the storing of the measured values, it is advantageous if the information carrier unit stores the measured values in a memory area of the memory.

Since, if the cable has a long service life, a multitude of measured values can be expected, and they would consequently require a very large memory to store them, in order to reduce the amount of data, it is preferably provided that the information carrier unit only stores a measured value in the memory area if it exceeds a threshold value.

This may take place, for example, by the information carrier unit constantly picking up the measured values, but the information carrier unit being prescribed a threshold value as from which the measured values are stored, so that normal states are not stored but only those measured values are stored which do not correspond to a normal state defined by the threshold value.

These measured values are then stored in the simplest case as nothing more than measured values, in somewhat more complex cases as measured values with an indication of the time at which they were picked up, or with an indication of other circumstances in which these measured values were picked up.

As an alternative to this, an advantageous solution provides that the information carrier unit only stores in the memory area measured values which lie outside a statistically determined normal measured value distribution.

With regard to the regions in which the state variables are determined by means of the sensor, no further details have been specified so far.

One advantageous solution provides that the sensor picks up at least one state variable of the inner cable body.

Another solution provides that the sensor picks up at least one state variable of the cable sheath.

Another solution provides that the sensor picks up at least one state variable between the inner cable body and the cable sheath.

In the case of a further embodiment, it is provided that both a sensor for state variables of the inner cable body and a sensor for state variables of the cable sheath are provided.

With regard to the type of sensor and the way in which it is formed, no further details have been specified so far.

An advantageous exemplary embodiment provides that the sensor is a sensor which reacts irreversibly to the state variable to be picked up.

A sensor of this kind has the advantage that it reacts irreversibly when the state variable occurs, so that it is not necessary for the sensor, and in particular the information carrier unit, to be active at the point in time of the occurrence of the state variable to be picked up or the occurrence of the deviation in the state variable to be picked up. Rather, the sensor is capable at all later points in time of generating a measured value which corresponds to the state variable that was achieved at some point in time in the past.

As an alternative to this, it is provided that the sensor is a sensor which reacts reversibly with regard to the state variable to be picked up. In this case, it is necessary to activate the sensor when the state variable to be picked up occurs or when there is a change in the state variable to be picked up, in order to be able to pick up the measured value corresponding to this state variable.

With regard to the forming of the cable sheath, no further details have been specified in connection with the exemplary embodiments described so far. In principle, the cable sheath may be an opaque cable sheath, in particular comprising fillers.

However, in order to be able, for example, to detect the information carrier unit, an advantageous solution provides that the cable sheath comprises a material that is transparent in the visible spectral range, so that the cable sheath makes it possible on the basis of its transparency to establish the location of the disposition of the information carrier unit in the longitudinal direction of the cable by optical examination of the cable.

This has the great advantage that reading out the information from one of the information carrier units of the cable is made easier, since the location of the information carrier unit can be easily established through the transparent cable sheath.

A further possible way of detecting the location of the information carrier unit that is easy and reliable for a user provides that the cable sheath bears an inscription and that the inscription is disposed in a defined relationship with the location of the information carrier unit, so that the inscription makes it possible to find the location of the information carrier unit in an easy way.

In this respect, there is a very wide range of possible ways of generating such a relationship with the inscription. For example, it is conceivable to dispose the information carrier unit either at the beginning or at the end of the inscription.

However, it is also conceivable to leave a gap in the inscription, which indicates where the information carrier unit is disposed in relation to the inscription.

As an alternative to this, however, it is also conceivable to provide special inscription symbols in the region of the inscription, which then comprise details of the location of the sensor.

Further features and advantages of the invention are the subject of the description and of the pictorial representation of some exemplary embodiments.

In the drawing:

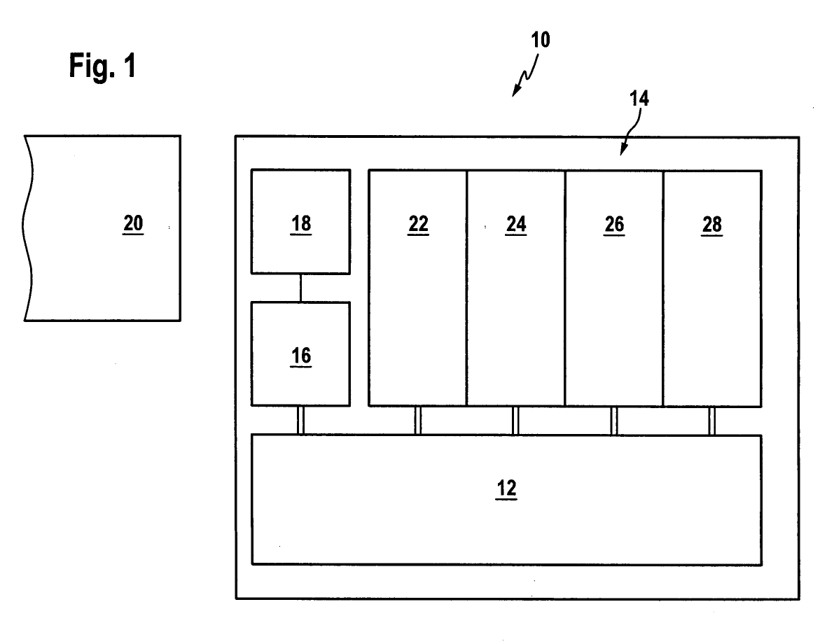

FIG. 1 shows a schematic block diagram of a first exemplary embodiment of an information carrier unit according to the invention;

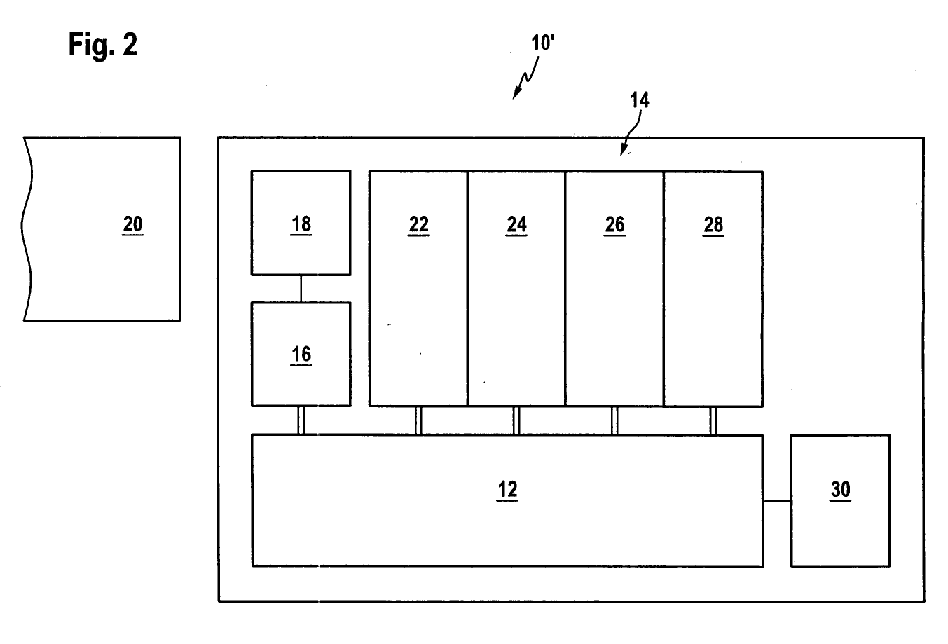

FIG. 2 shows a block diagram similar to FIG. 1 of a second exemplary embodiment of an information carrier unit according to the invention;

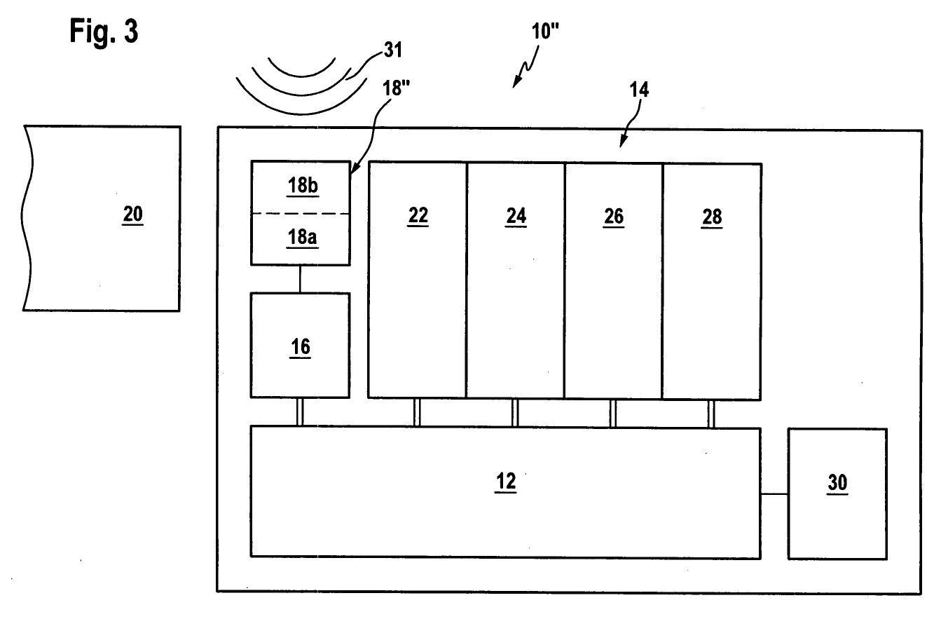

FIG. 3 shows a block diagram similar to FIG. 1 of a third exemplary embodiment of an information carrier unit according to the invention;

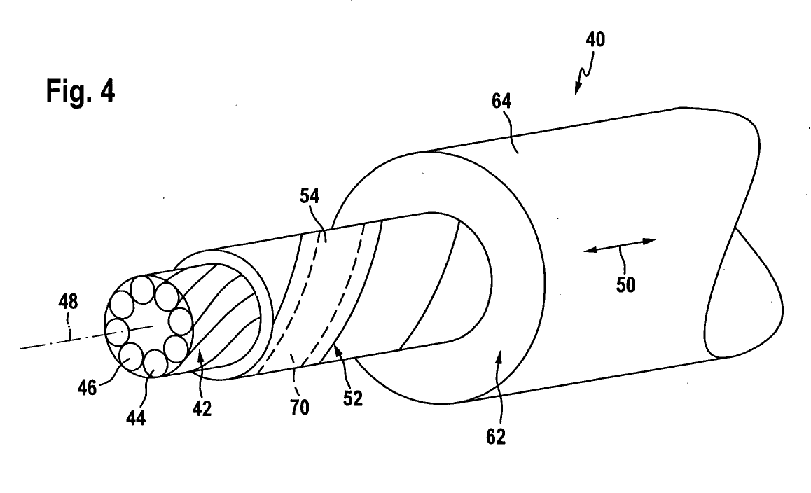

FIG. 4 shows a perspective representation of a first exemplary embodiment of a cable according to the invention;

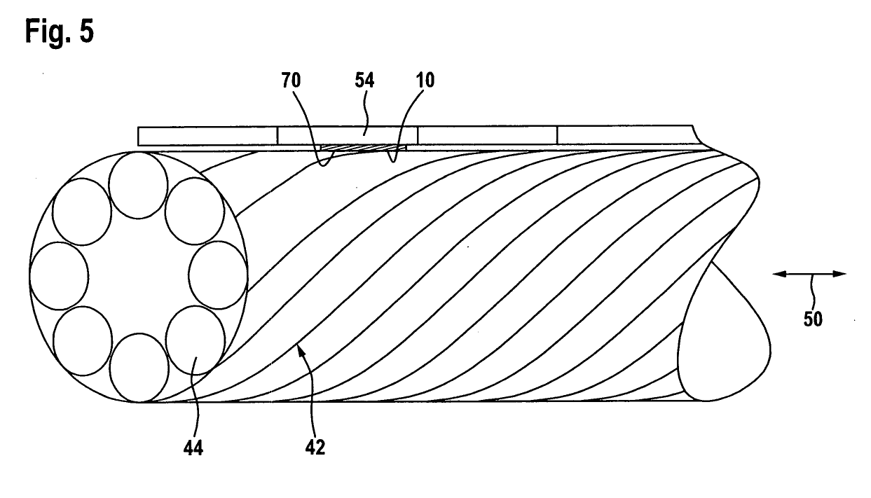

FIG. 5 shows a section through the separating layer in FIG. 4 in the region of the information carrier unit;

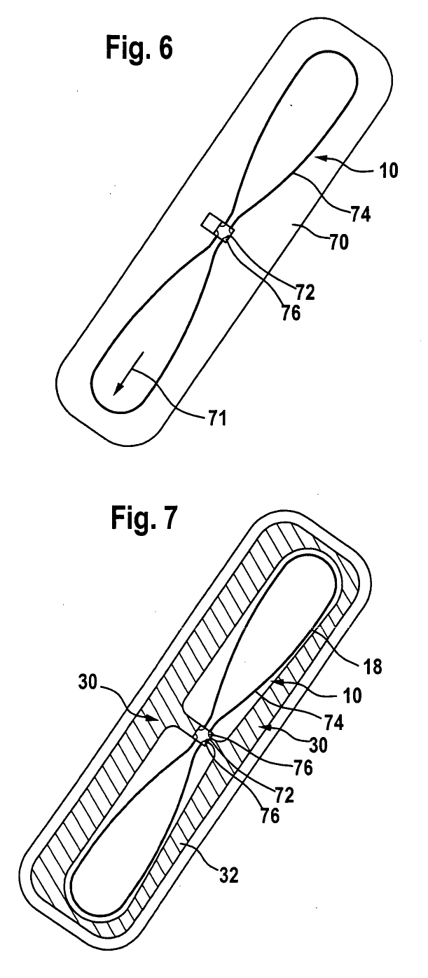

FIG. 6 shows a plan view of a way of realizing the information carrier unit used in FIGS. 5 and 6;

FIG. 7 shows a plan view similar to FIG. 6 of a first variant of the way in which the information carrier unit is realized;

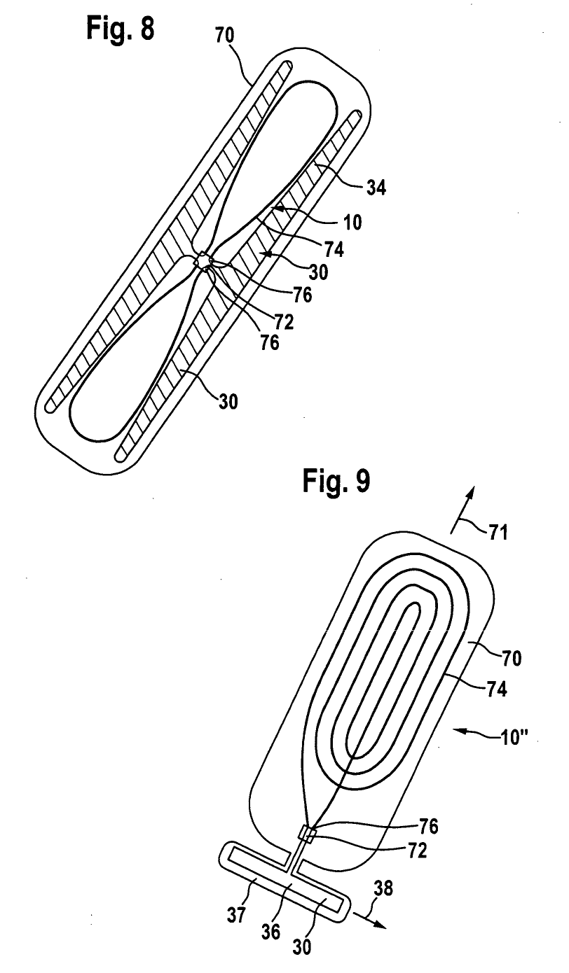

FIG. 8 shows a plan view similar to FIG. 6 of a second variant of the way in which the information carrier unit is realized;

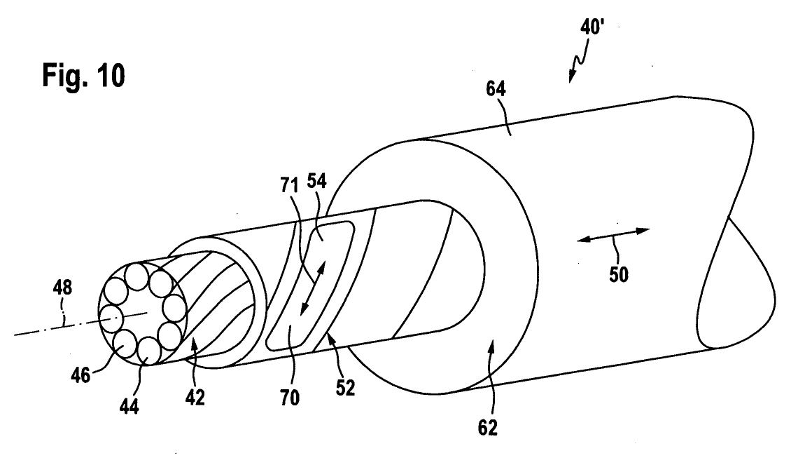

FIG. 9 shows a plan view similar to FIG. 6 of a third variant of the way in which the information carrier unit is realized;

FIG. 10 shows a representation similar to FIG. 4 through a second exemplary embodiment of an information carrier unit according to the invention;

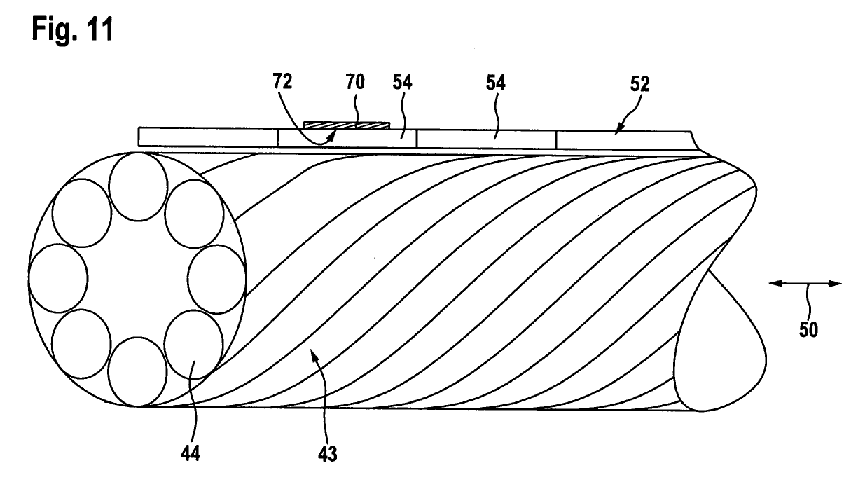

FIG. 11 shows a section similar to FIG. 5 through the second exemplary embodiment of the cable according to the invention;

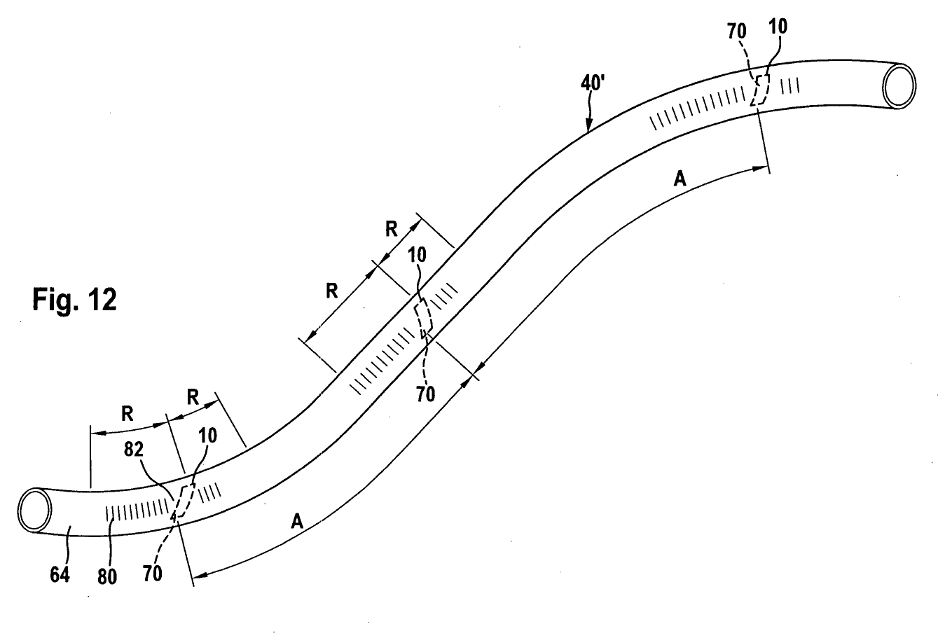

FIG. 12 shows a perspective representation of a piece of cable according to the second exemplary embodiment of the cable according to the invention;

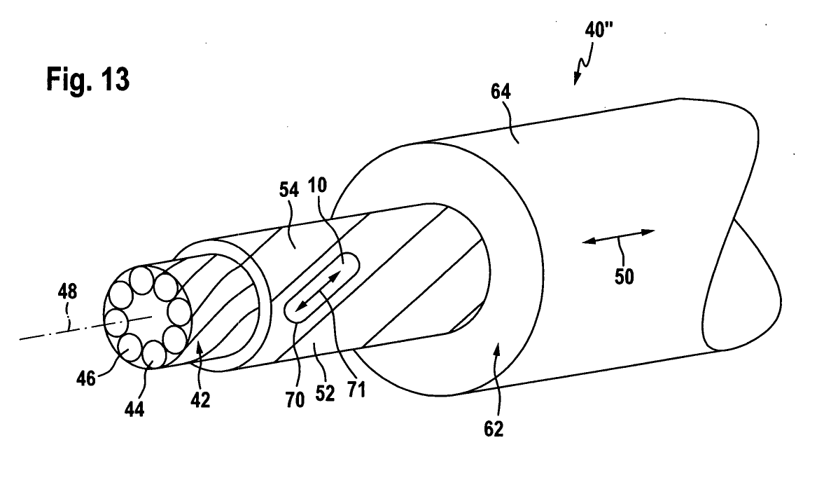

FIG. 13 shows a representation similar to FIG. 4 of a third exemplary embodiment of a cable according to the invention;

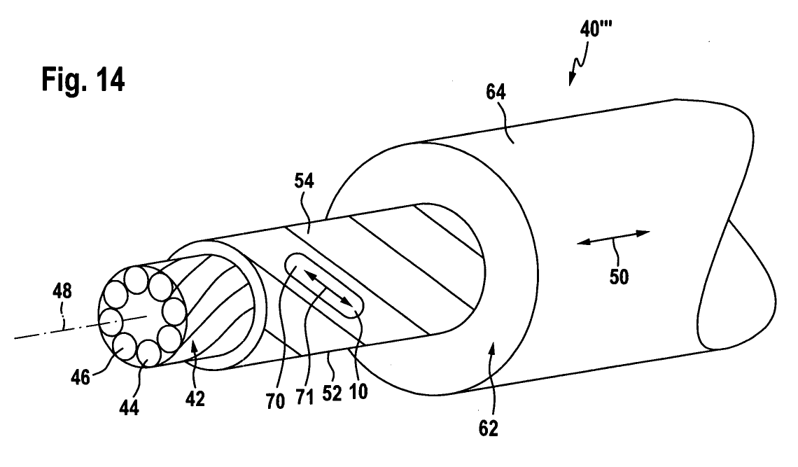

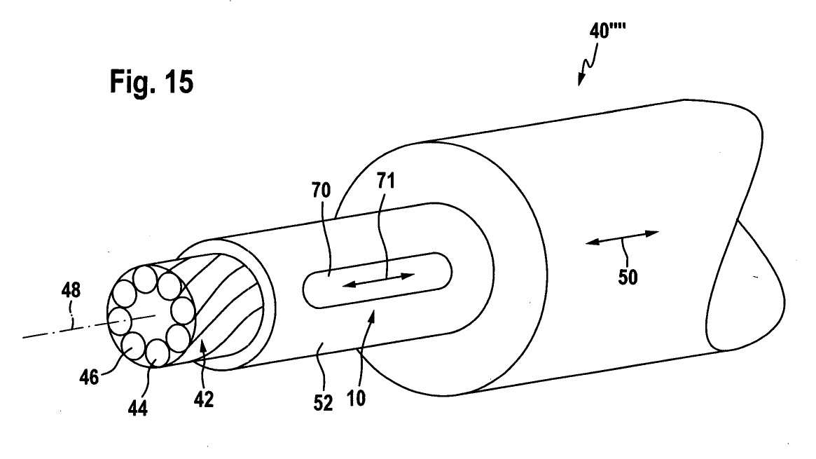

FIG. 14 shows a representation similar to FIG. 4 of a fourth exemplary embodiment of a cable according to the invention;

FIG. 15 shows a representation similar to FIG. 4 of a fifth exemplary embodiment of a cable according to the invention;

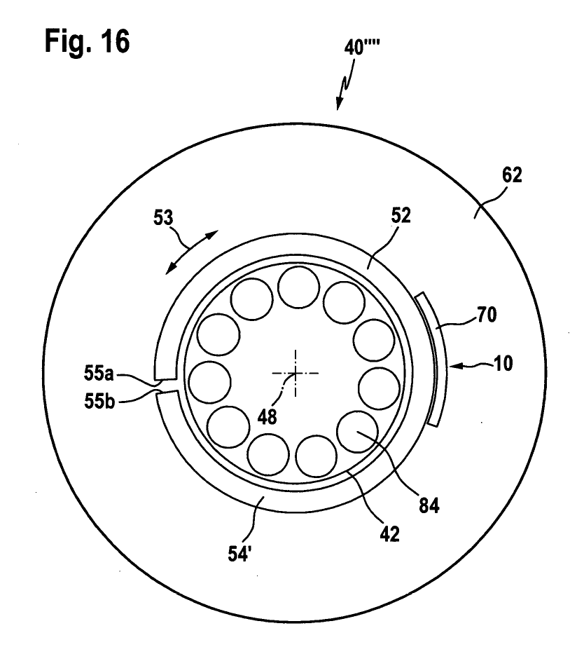

FIG. 16 shows a cross-section through the fifth exemplary embodiment of the cable according to the invention;

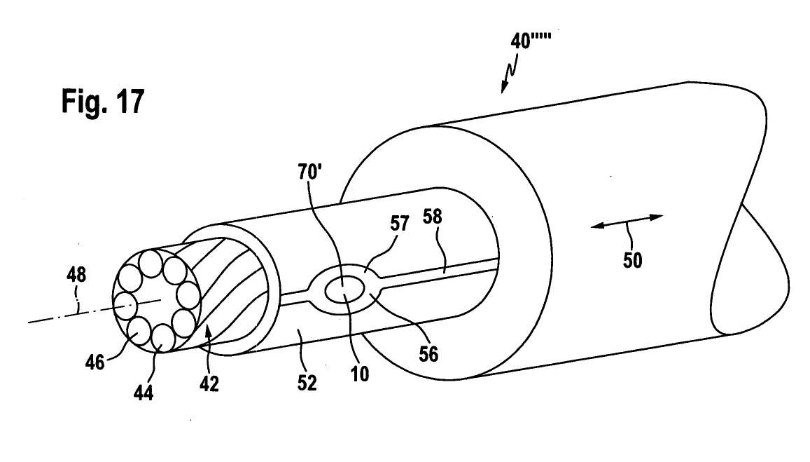

FIG. 17 shows a representation similar to FIG. 4 of a sixth exemplary embodiment of a cable according to the invention;

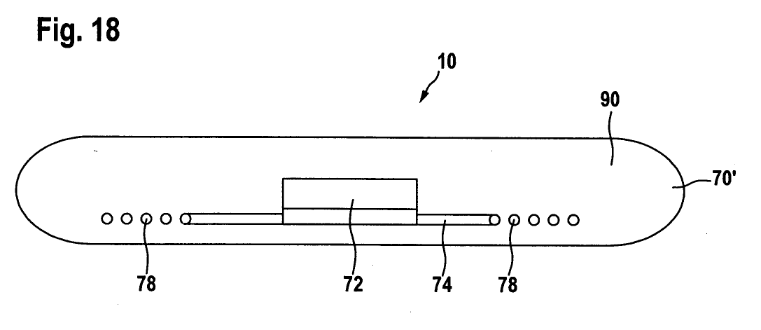

FIG. 18 shows a section through the information carrier unit of the sixth exemplary embodiment of the cable according to the invention;

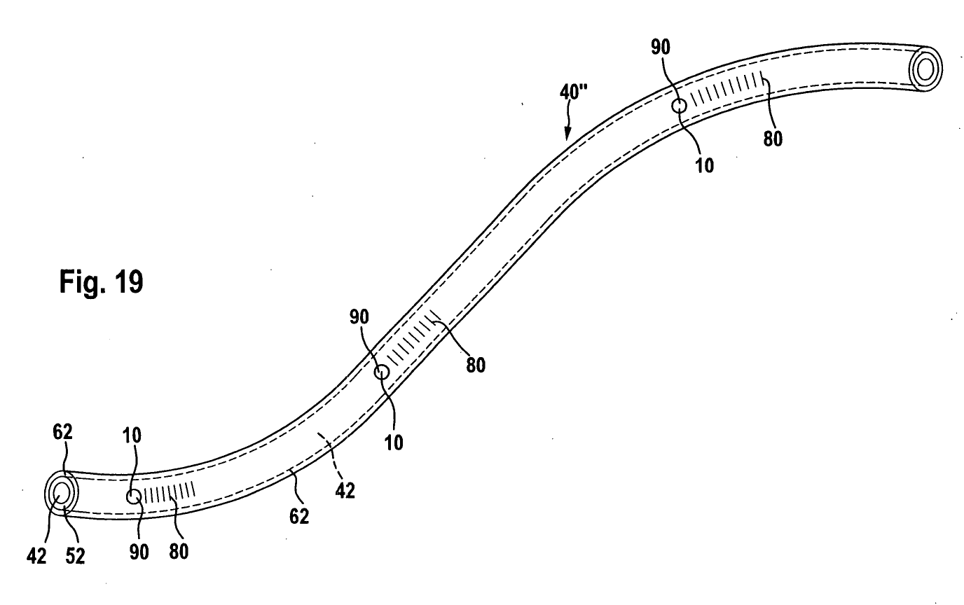

FIG. 19 shows a perspective representation of a piece of cable similar to FIG. 9 of the sixth exemplary embodiment of a cable according to the invention;

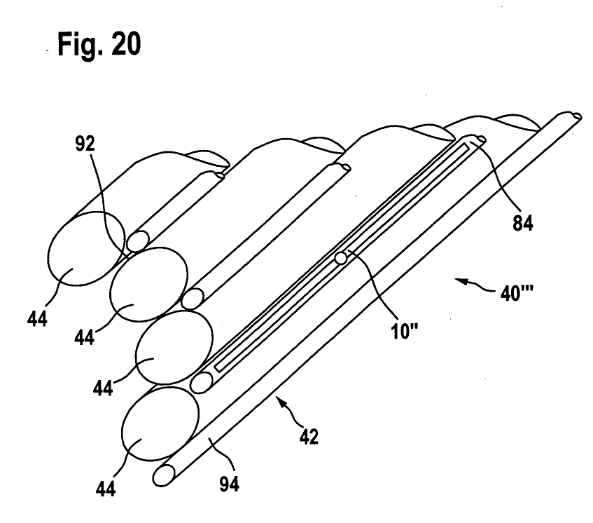

FIG. 20 shows a perspective representation of a seventh exemplary embodiment of a cable according to the invention, merely represented in the region of an inner cable body;

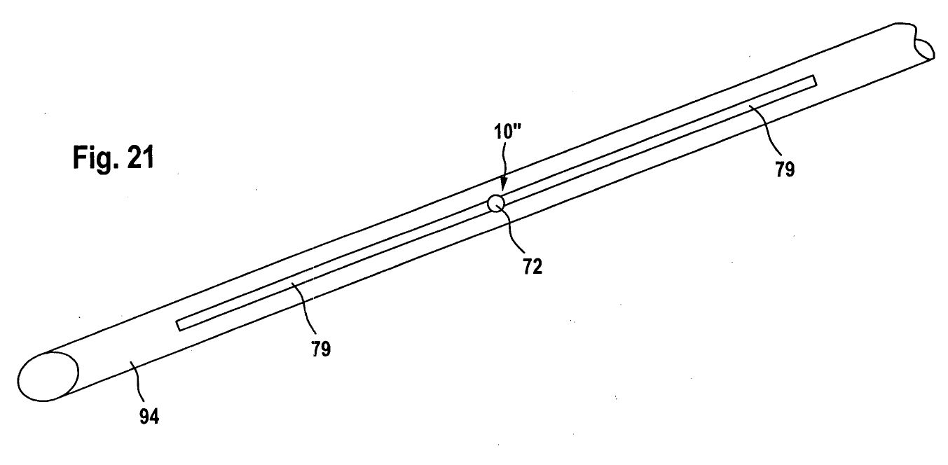

FIG. 21 shows a perspective representation of a portion of an interstitial cord with an information carrier unit in the case of the seventh exemplary embodiment and

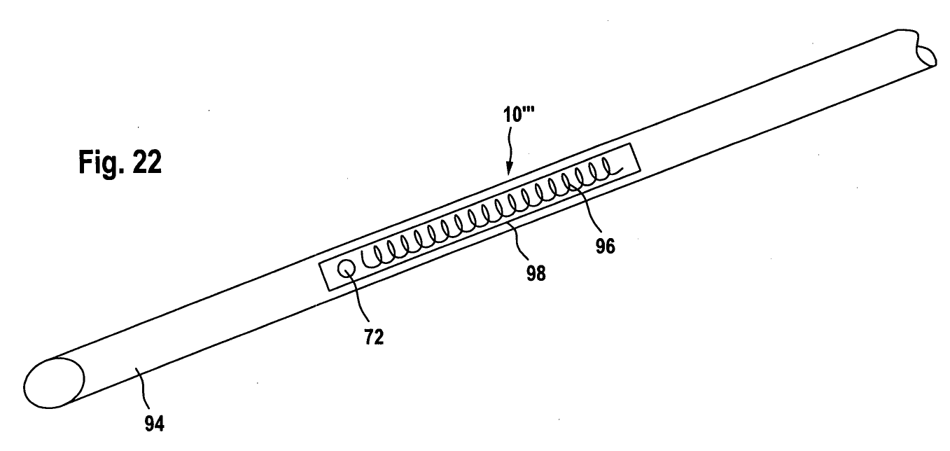

FIG. 22 shows a perspective representation of a portion of the interstitial cord in the case of an eighth exemplary embodiment of the cable according to the invention.

An exemplary embodiment of an information carrier unit 10 to be used according to the invention and represented in FIG. 1 comprises a processor 12, to which a memory designated as a whole by 14 is linked, the memory preferably being formed as an EEPROM.

Also connected to the processor 12 is an analog part 16, which interacts with an antenna unit 18.

When there is electromagnetic coupling of the antenna unit 18 to a read device designated as a whole by 20, the analog part 16 is then capable on the one hand of generating, with the required power, the electrical operating voltage that is necessary for the operation of the processor 12 and the memory 14, as well as the analog part 16 itself, and on the other hand of making available to the processor 12 the information signals transmitted by electromagnetic field coupling at a carrier frequency or transmitting information signals generated by the processor 12 by way of the antenna unit 18 to the read device 20.

A very wide variety of carrier frequency ranges are possible thereby.

In an LF range of approximately 125 to approximately 135 kHz, the antenna unit 18 acts substantially as a second coil of a transformer formed by the antenna unit and the read device 20, energy and information transmission taking place substantially by way of the magnetic field.

In this frequency range, the range between the read device 20 and the antenna unit 18 is low, that is to say that, for example, the mobile read device 20 must be brought up very close to the antenna unit 18, to within less than 10 cm.

In an HF range between approximately 13 and approximately 14 MHz, the antenna unit 18 likewise acts substantially as a coil, good energy transmission with a sufficiently great range being possible as before in the interaction between the antenna unit 18 and the read device 20, the distance being, for example, less than 20 cm.

In the UHF range, the antenna unit 18 is formed as a dipole antenna, so that, when the power supply to the information carrier unit 10 does not take place by way of the mobile read device 20, a great range in the communication with the read device 20 can be realized, for example up to 3 m, the interaction between the read device 20 and the antenna unit 18 taking place by way of electromagnetic fields. The carrier frequencies are from approximately 850 to approximately 950 MHz or from approximately 2 to approximately 3 GHz or from approximately 5 to approximately 6 GHz. When the power is supplied by the mobile read device 20, the communication range is up to 20 cm.

Depending on the frequency range, therefore, the antenna units 18 are also differently formed. In the LF range, the antenna unit 18 is formed as a compact, for example wound, coil with an extent which may even be less than one square centimeter.

In the HF range, the antenna unit 18 is likewise formed as a flat coil, which may also have a greater extent of the order of several square centimeters.

In the UHF range, the antenna unit 18 is formed as a dipole antenna of diverse configurations.

The memory 14 interacting with the processor 12 is preferably divided into a number of memory areas 22 to 28, which can be written to in various ways.

For example, the memory area 22 is provided as a memory area which can be written to by the manufacturer and, for example, carries an identification code for the information carrier unit 10. This identification code is written in the memory area 22 by the manufacturer, and at the same time the memory area 22 is write-protected.

The memory area 24 can, for example, be provided with write protection which can be activated by the cable manufacturer, so that the cable manufacturer has the possibility of writing to the memory area 24 and securing the information in the memory area 24 by write protection. In this way, the processor 12 has the possibility of reading and outputting the information present in the memory area 24, but the information in the memory area 24 can no longer be overwritten by third parties.

For example, the information stored in the memory area 24 may be information concerning the kind or type of cable and/or technical specifications of the cable.

In the memory area 26, information is stored, for example, by the purchaser of the cable and write-protected. Here there is the possibility for the purchaser and user of the cable to store information concerning the installation and use of the cable and secure it by write protection.

In the memory area 28, information can be freely written and freely read, so that this memory area can be used for storing and reading information during the use of the information carrier unit in conjunction with a cable.

The exemplary embodiment of the information carrier unit 10 represented in FIG. 1 is a so-called passive information carrier unit, and consequently does not require an energy store, in particular an accumulator or battery, in order to interact and exchange information with the read device 20.

In the case of a second exemplary embodiment of an information carrier unit 10′ according to the invention, represented in FIG. 2, those elements that are identical to those of the first exemplary embodiment are provided with the same reference numerals, so that, with regard to the description of the same, reference can be made to the first exemplary embodiment in its entirety.

By contrast with the first exemplary embodiment, in the case of the second exemplary embodiment, a sensor 30 is also associated with the processor 12, the sensor enabling the processor 12 to pick up physical variables of the cable, such as for example radiation, pressure, temperature, tension or moisture, and for example to store corresponding values in the memory area 28.

The sensor 30 may in this case be formed in accordance with the field of use.

For example, it is conceivable to form the sensor 30, for measuring a pressure, as a pressure-sensitive layer, it being possible for the pressure sensitivity to take place for example by way of a resistance measurement or, in the case of multiple layers, a capacitive measurement.

As an alternative to this, it is, for example, conceivable, for forming the sensor as a temperature sensor, to form the sensor as a resistor that is variable with the temperature, so that a temperature measurement is possible by a resistance measurement.

If the sensor is formed as a tension or elongation sensor, the sensor is formed, for example, as a strain gage, which changes its electrical resistance in accordance with the elongation.

If, however, the sensor is formed as a sensor reacting irreversibly to a specific elongation or to a specific tension, it is likewise possible to form the sensor as a sensor breaking an electrical connection, for example as a wire or conductor track for which the electrical connection is interrupted as from a specific tension of a specific elongation, by rupturing at a predetermined breaking point or by tearing, or goes over from a low resistance to a high resistance.

If appropriate, however, the tension measurement or the elongation measurement could also be realized by a capacitive measurement.

In the case of a moisture sensor, the sensor is preferably formed as a multilayer structure which changes its electrical resistance or its capacitance in accordance with moisture.

Otherwise, the second exemplary embodiment according to FIG. 2 operates in the same way as the first exemplary embodiment.

By contrast with the second exemplary embodiment, in the case of a third exemplary embodiment 10″, represented in FIG. 3, the analog part 16 has an associated antenna unit 18″, which has a two-part effect, to be specific for example an antenna part 18a, which communicates in a known way with the read device 20, and an antenna part 18b, which is capable, by induction, of coupling to an alternating magnetic field 32 and drawing energy from it, in order to operate the information carrier unit 10″ independently of the read device 20 with this energy drawn from the alternating magnetic field 32.

For example, the alternating electromagnetic field 32 can be produced by the leakage field of an alternating current line which is connected, for example, to an AC voltage source with 50 Hz. It is in this way possible to supply the information carrier unit 10″ with energy as long as the alternating field 31 exists, irrespective of whether the read device 20 is intended to be used for writing or reading information.

Supplying the information carrier unit 10″ with electrical energy in such a way, independently of the read device 20, is useful in particular if the sensor 30 is intended to be used over relatively long time periods for picking up a physical variable which is not intended to coincide with the time period during which the read device 20 is coupled to the antenna unit 18a but to be independent of it.

Consequently, for example, the information carrier unit 10″ can be activated by switching on the alternating electromagnetic field 31, so that physical state variables can be measured by the sensor 30 and picked up by way of the processor 12, and for example stored in the memory area 28, independently of the question as to whether or not the read device 20 is coupled with the antenna unit 18.

For example, the alternating electromagnetic field 31 may be produced by the stray field of a data line, a control line, a pulsed power line or an alternating current line, which is, for example, connected to an AC voltage source with 50 Hz or a higher frequency. It is in this way possible to supply the information carrier unit 10 with energy as long as the alternating field 31 exists, irrespective of whether the read device 20 is intended to be used for writing or reading information.

The frequency of the alternating field 31 and the resonant frequency of the antenna part 18b can be made to match each other in such a way that the antenna part 18b is operated in resonance, and consequently allows optimum coupling-in of energy from the alternating field 31.

Supplying the information carrier unit 10 with electrical energy in such a way, independently of the read device 20, is useful in particular if the sensor is intended to be used over relatively long time periods for picking up a physical state variable which is not intended to coincide with the time period during which the read device 20 is coupled to the antenna unit 18a but to be independent of it.

Consequently, for example, the information carrier unit can be activated by switching on the alternating electromagnetic field 31, so that physical state variables can be measured by the sensor 30 and picked up by way of the processor 12, and for example stored in the memory area 28, independently of the question as to whether or not the read device 20 is coupled with the antenna unit 18.

An information carrier unit corresponding to the exemplary embodiments described above can be used for a cable according to the invention in different variants.

A first exemplary embodiment of a cable 40, represented in FIG. 4, comprises an inner cable body 42, in which a number of electrical conductor strands 44 run, the electrical conductor strands 44 respectively comprising, for example, a core 46 of an electrical conductor, which is insulated.

In this case, the electrical conductor strands 44 are preferably twisted with one another about a longitudinal axis 48, that is to say they lie disposed about the longitudinal axis 48 and run at an angle to a parallel to the longitudinal axis 48 that intersects the respective conductor strand 44.

The inner cable body 42 is enclosed by a separating layer 52, which separates the inner cable body 42 from a cable sheath 62 that encloses the inner cable body 42 and forms an outer surface 64 of the cable.

In the case of the exemplary embodiment represented in FIG. 4, the separating layer 52 is formed by a strip 54, which is wound around the inner cable body 42, to be precise with a pitch which deviates from that of the twisted conductor strands 44.

The strip 54 is, for example, a nonwoven strip, which, during the production of the cable 40, is wound around the inner cable body 42 over its complete area, either not overlapping or overlapping, before the extrusion of the cable sheath 62 and, as represented in FIG. 5, carries on its side facing the inner cable body 42, the information carrier unit 10, which is disposed on a base 70.

In the state of the information carrier unit 10 that is represented as a developed view in FIG. 6, a base 70 of said unit extends in a longitudinal direction 71 and carries an integrated circuit 72, which comprises the processor 12, the memory 14 and the analog part 16, as well as conductor tracks 74, which are provided on the base 70 and form the antenna unit 18. The conductor tracks 74 may in this case be applied to the base 70 by means of any desired form-selective coating processes, for example in the form of printing a conductive lacquer or a conductive paste.

If the information carrier unit 10 is of a great extent, the base 70 is, for example, a flexible material, in particular a pliant material, for example a plastics strip, to which on the one hand the conductor track 74 can be easily and permanently applied by coating and on the other hand the integrated circuit 72 can also be easily fixed, in particular in such a way that a permanent electrical connection can be realized between external connecting points 76 of the integrated circuit 72 and the conductor tracks 74.

In the case of the first exemplary embodiment, the base is then disposed, as represented in FIG. 5, in such a way that it is facing the inner cable body 42, in particular the conductor strands 44, so that the integrated circuit 72 and the conductor tracks 74 are facing the strip 54, and consequently are disposed in a protected manner between the strip 54 and the base 70, in order to avoid damage to the conductor track 74 as early as during cable production, in particular in the region of the external connecting points 76. Furthermore, the base 70 lies on the inner cable body 42 with a side that does not hinder sliding on the inner cable body 42, and consequently does not disturb the frictional conditions between the inner cable body and the separating layer 52 fixedly connected to the cable sheath 62.

For example, the base 70 is flexibly bonded to the strip 54 by an adhesive, to be precise before the strip 54 is wound around the cable body 42, so that the information carrier unit 10 can also be easily introduced and integrated in the cable in a defined manner while the strip 54 is being wound around the inner cable body 42.

The strip 54 preferably thereby covers over the inner cable body 42 substantially completely, so that it brings about a mechanical separation of the inner cable body 42 and the cable sheath 62 and substantially defines the frictional conditions for the inner cable body 42 moving in relation to the strip 54 during the bending of the cable 40.

In the case of a first variant of this exemplary embodiment, represented in FIG. 7, the information carrier unit 10′ also comprises the sensor 30, which may, for example, be a radiation sensor for all types of physical radiation, a temperature sensor, a tension or elongation sensor or a moisture sensor, which is formed over a large area as a layer 32 and is disposed on the base 70 along with the antenna unit 18, as represented in FIG. 7.

In the case of a second variant of the first exemplary embodiment that is represented in FIG. 8, the sensor 30 is formed as a multilayer structure 34 and can consequently be operated with a space-saving structure as a capacitive sensor 30. In this case, moisture, temperature or pressure can be easily picked up in particular on the basis of the state-dependent capacitance.

Such a sensor 30 can be easily contacted by the integrated circuit or be formed as part of the same.

If the base 70 is formed as flat material, it is of advantage if it is formed with edge regions with a blunt effect on their surroundings, in order to avoid damage to the surroundings of the base 70 in the cable 40 during movement of the cable. This means in the case of a base 70 formed from a thin flat material that it has, for example, rounded corner regions and, if possible, also edges with a blunt effect, for example deburred edges.

In the case of a third variant of the first exemplary embodiment, the sensor 30 is formed as a strain gage 36, which in the case of this exemplary embodiment is disposed on a substrate 37 which is connected to the base 70 and can be elongated in a longitudinal direction 38 of the strain gage 36.

In the case of this exemplary embodiment, the substrate 37, together with the strain gage 36, can be advantageously fixed on the part to be measured or embedded in it, so that the elongation of this part or of the surroundings of the substrate 37 is transmitted to the substrate 37, and consequently the substrate 37 can pick up the elongation of its surroundings and transmit it to the strain gage 36 without distortion.

In the case of this exemplary embodiment, the longitudinal direction 38 runs, for example, transversely to the direction 71, which represents a longitudinal direction of the base 70, but may also run parallel thereto.

Consequently, provided that the strain gage 36 is fixedly connected to a component part of the cable that can undergo elongation, in the case of this information carrier unit 10″, it is possible for elongations in the longitudinal direction 38 of the strain gage 36 to be measured and to be picked up by the processor 12 on the integrated circuit 72.

If the information carrier unit is formed according to the third exemplary embodiment 10″, the strain gage 36 according to FIG. 9 is firmly fixed on the strip 54, in particular together with the substrate 37, the longitudinal direction 71 of the base 70 running approximately parallel to the longitudinal direction 56 of the strip 54, so that tension or elongations can be picked up by the strain gage 36, for example transversely to the longitudinal direction 56 of the strip 54.

The elongations of the strip 54 are then representative of the stressing of the cable 40 during the bending of the same and in the case of this exemplary embodiment can be picked up by the processor 12, stored if appropriate, and read out by means of the read device 20.

The strain gage 36 may either be made of a material that tears under tension or elongation, so that the electrical resistance thereof increases irreversibly, for example becomes very great, when a threshold value for the tension or elongation is exceeded.

Or else the strain gage 36 may be made of a material that reversibly changes its resistance with the tension occurring or the elongation occurring.

If shear stresses in the cable 40, for example shear stresses between the cable sheath 62 and the inner cable body 42, are to be picked up by the strain gage 36, the substrate 37 is fixed, for example by adhesion, with one end on the inner cable body 42 and an upper side of the respective strain gage 36 that is facing away from the substrate 37 is fixed to the strip 54 with the end lying opposite in the longitudinal direction 38, an intimate bond existing in the finished cable 40 between the strip 54 and the cable sheath 62 extruded onto the strip, so that the strain gages 36 can then be used to pick up relative movements between the inner cable body 42 and the cable sheath 62 with the strip 54 fixed in relation to the latter.

The fact that—as already described—the base 70 has blunt edge regions means that the inner cable body 42 is not damaged during the bending of the cable 40, although the base 70 lies directly on the inner cable body 42.

In the case of a second exemplary embodiment of a cable 40′ according to the invention, represented in FIGS. 10 and 11, the base 70 is disposed on a side of the strip 54 that is facing away from the inner cable body 42, the strip wrapping around said inner body over the complete area of the inner body, to be precise in such a way that the integrated circuit 72 with the conductor tracks 74 likewise lies between the base 70 and the strip 54, and is consequently protected on both sides.

In this case, too, the information carrier unit 10 can be introduced into the inner cable body 42 in a defined manner while said inner body is being wound around during the production of the cable 40′, the information carrier unit 10 being embedded in the cable sheath 62, and consequently fixed, together with the separating layer 52, on the cable sheath 62, so that in the case of flexible and highly flexible cables, no disturbance of the friction between the inner cable body 42 and the separating layer 52 can be caused by the information carrier unit 10.

The information carrier unit 10 according to the first and second exemplary embodiments of the cable according to the invention is formed, for example, as an information carrier unit 10 which operates in the HF or UHF range, that is to say has an antenna unit 18, the extent of which is, for example, several square centimeters.

In the case of the second exemplary embodiment, represented in FIGS. 10 and 11, the fact that the base 70 is disposed on the side of the separating layer 52 that is facing away from the inner cable body 42 provides the possibility of optically detecting the base 70 of the information carrier unit 10, if the cable sheath 62 is produced from a material that is transparent in the visible range.

Such a solution is represented in FIG. 12, a number of information carrier units 10 being disposed one after the other at uniform distances A in the longitudinal direction 50 of the cable 40′, so that the information carrier units 10 follow one after the other at defined geometrical intervals, that is, spaced apart by the distance A, over the entire length of the cable 40′.

There is consequently the possibility, for example, of indicating a position in the longitudinal direction of the cable 40′ by the information carrier units 10, so that, after reading one of the information carrier units 10, it is evident at what distance said unit is positioned from one of the ends of the cable 40′.

For this purpose it is also possible, for example, for the user to write information concerning the position of the respective information carrier unit 10, for example the distance thereof from the two ends of the cable 40′, to the memory area 26.

If, furthermore, the base 70 is produced in a color that is distinctly different from the color of the separating layer 52, it is possible, when the cable sheath 62 is made such that it is transparent in the visible spectral range, to detect the position of the respective information carrier units 10 even from the outside and address them in a defined manner with the read device 20, in order to read out the information from each of the information carrier units 10.

In order to make it easier to find the information carrier units 10 on the cable, it is preferably provided that the cable sheath 62 bears an inscription 80 on the outer surface 64 of the cable, said inscription additionally comprising a gap 82, the information carrier unit 10 being disposed in the cable 40′ in line with the gap 82 in the inscription.

It is consequently possible by moving the read device toward the gap 82 in the inscription to address the information carrier unit 10 with the read device 20, and read out from it, without closer inspection of the cable 40′.

Preferably, the inscription 80 with the gap 82 in the inscription is associated with each position of an information carrier unit 10, in order in this way to make it easier to find the information carrier unit 10.

Even if, in the case of this embodiment, the cable sheath 62 is not transparent, there is likewise the possibility of easily finding and reading the information carrier unit 10 in the cable 40′ simply by moving to the gap 82 in the inscription.

In the case of this second exemplary embodiment, furthermore, a reading/writing range R of the information carrier units is selected such that the reading/writing range R of the individual information carrier units 10 does not overlap in the longitudinal direction 50 of the cable 40, but instead there are sufficient intermediate spaces between the respective reading/writing ranges R, so that each of the information carrier units 10 can be individually addressed and read with the read device 20.

In the simplest case, the distance A between the information carrier units 10 is in this case at least 2 times the reading/writing range R of the information carrier units 10; still better are greater distances, for example at least 2.5 times the reading/writing range R.

In the case of a third exemplary embodiment of a cable 40″ according to the invention, represented in FIG. 13, by contrast with the second exemplary embodiment, the run of the strip 54 forming the separating layer 52 is chosen such that it runs substantially parallel to the conductor strands 44 twisted with one another, so that the information carrier unit 10, in particular the base 70 of the same, also extends with its longitudinal direction 71 likewise approximately parallel to the run of the conductor strands 44 twisted with one another about the longitudinal axis 48.

Otherwise, to the extent that the same parts are provided with the same reference numerals, this third exemplary embodiment of the cable 40″ according to the invention corresponds to the second and first exemplary embodiments, so that reference can be made to the statements made about the latter in their entirety.

In the case of a fourth exemplary embodiment of a cable 40′″ according to the invention, represented in FIG. 14, the strip 54 runs in the opposite direction to the conductor strands 44 twisted with one another about the longitudinal axis 48, so that the longitudinal direction 71 of the base 70 and the conductor strands run obliquely or transversely in relation to one another.

Otherwise, also in the case of the fourth exemplary embodiment, those parts that are identical to those of the previous exemplary embodiments are provided with the same reference numerals, so that, with regard to the description of the same, reference can be made to the statements made about the previous exemplary embodiments in their entirety.

In the case of a fifth exemplary embodiment of the cable 40″″ according to the invention, represented in FIGS. 15 and 16, the separating layer 52 is formed by a so-called filler tape 54, which substantially encloses the inner cable body 42 in a circumferential direction 53 and has longitudinal edges 55a, 55b, which substantially abut one another or run at a small spacing from one another or even overlap one another, so that complete envelopment of the inner cable body 42 is substantially ensured.

In this case, the filler tape carries the information carrier unit 10, which extends with the longitudinal direction 71 of the base 70 approximately parallel to the longitudinal direction 50 of the cable 40″″, the base 70 substantially engaging snugly against the filler tape 54′ in the circumferential direction 53. The information carrier unit 10 in this case preferably lies on a side of the separating layer 52 that is facing away from the inner cable body 42 and is embedded together with the separating layer 52 in the material of the cable sheath 62 during the extrusion of the same.

This ensures that the information carrier unit 10 does not in any way disturb or impair the friction between the inner cable body 42 and the separating layer 52, so that even in the case of highly flexible cables, there is no disturbance whatever of the cable symmetry and cable geometry, and consequently also, in particular, the relative movement between the inner cable body 42 and the separating layer 52 remains completely uninfluenced by the information carrier unit 10.

There is also the possibility, however, as represented in FIGS. 17 and 18, in the case of a sixth exemplary embodiment of a cable 40′″″ according to the invention, of producing the information carrier unit 10 as a disk-shaped round formation, which is held on a carrier strip 54 that lies on a side of the separating layer 52 facing away from the inner cable body 42 and extends parallel to the longitudinal direction 50 of the cable 40′″″ over the entire length thereof, the carrier strip 54 being provided at defined intervals with an information carrier unit 10 formed as a disk. As represented in FIG. 17, this information carrier unit 10 preferably likewise comprises the integrated circuit 72, which is likewise connected to conductor tracks 74 forming the antenna unit 18, the conductor tracks 74 forming, for example, annular coil windings 78 for an antenna in the HF range, and both the conductor tracks 74 and the integrated circuit 72 being embedded in an embedding compound 90, for example of resin or plastics material, forming the base 70′.

Consequently, the information carrier unit 10 is in this case a disk-like rigid body with rounded edge regions, which is introduced into the cable 40 during the production thereof by feeding in the carrier strip 54 and is positioned at defined intervals within the cable 40. However, it is also possible to form the information carrier unit 10 as a lenticular or semilenticular body. With such shaping, damage to surroundings in the cable during the bending of the cable can be avoided.

For receiving the base 70′, the carrier strip 54 is in this case provided with enlarged regions 57, onto which the respective base 70′ of the corresponding information carrier unit is adhesively attached, the enlarged regions 57 being joined by narrow regions 58 of the carrier strip 54, which respectively extend between the enlarged regions 57.

In the case of this exemplary embodiment of the cable 40′″″ according to the invention, the carrier strip 54 is preferably likewise placed-on with the separating layer 52, irrespective of how the latter is applied to the inner cable body 42, such placement of the carrier strip 54 taking place with a molding tool in a way similar to application of a filler tape of the cable.

Also in the case of this exemplary embodiment, the information carrier unit 10 can be seen through the cable sheath 62 if the cable sheath 62 is formed from a material that is transparent in the visible spectral range, so that the embedding body 90 of the information carrier unit that is located on the inner cable body 42 can be seen through the cable sheath 62 if this embedding body 90 is of a distinctly different color from the separating layer 52 on which it is disposed, as illustrated in FIG. 19.

If the position of the information carrier units 10 cannot be easily found in order to locate said units, an inscription 80 may also be additionally provided, for example with a gap 82 in the inscription.

However, it is also conceivable in the case of this exemplary embodiment to dispose the inscription 80, for example, in such a way that the position at which the information carrier unit 10 can be found in the longitudinal direction 50 of the cable 40 is indicated by the beginning of the inscription 80 or the end of the same or by an element of the inscription.

In the case of a seventh exemplary embodiment of a cable 40″″″ according to the invention, represented in FIG. 20, interstitial cords 94 lie in the inner cable body 42, between the electrical conductor strands 44, to compensate for the interstices 92 that are present, said cords being twisted with the electrical conductor strands 44 and an information carrier unit 10″ being integrated in one of the interstitial cords 94.

For example, as represented in FIG. 21, in this case the integrated circuit 72 lies within the interstitial cord 94 and thin wires 79 extend on both sides of the integrated circuit 72, forming the antenna unit 18, which in the UHF range is preferably formed as a dipole antenna, so that merely a single wire 79 runs on both sides of the integrated circuit 72 and, like the integrated circuit 72, said wire being likewise embedded in the interstitial cord 94, as shown in FIG. 21.

In the case of the solution according to the invention, the interstitial cord 94 thereby forms the carrier strand in which the information carrier unit 10″ is located and by which the information carrier unit 10″ can be introduced into the cable 40″″”, that is, in a simple manner by the interstitial cord 94 being twisted together with the electrical conductor strands 44 in a known manner to form the inner cable body 42.

Also, when the information carrier unit 10″ is introduced into the interstitial cord 94, there is the possibility of providing the information carrier units 10″ at defined intervals A along the interstitial cord 94, a defined disposition of the information carrier units 10″ being possible once again at defined intervals in the longitudinal direction 50 of the cable 40″″″.

In the case of this exemplary embodiment, the information carrier unit 10 can be operated in the UHF range, since the antenna unit 18 is preferably formed as a dipole.

However, as an alternative to this, as represented in FIG. 22, there is also the possibility of forming the antenna unit 18 as an elongate coil 96 and embedding it in a protective sheath 98, it being possible for the information carrier unit 10′″ to be operated in the LF range.

Also when the information carrier units 10″ or 10′″ are provided in the interstitial cords 94, there is the possibility of making it easier to find them at the respective locations in the longitudinal direction 50 of the respective cable 40′″ by making the location of the respective information carrier unit 10″ or 10′″ respectively correlate with the inscription 80 on the outer surface 64 of the cable.

1-52. (canceled)

53. Cable, comprising an inner cable body, in which at least one conductor strand of an optical and/or electrical conductor runs in the longitudinal direction of the cable, a cable sheath, enclosing the inner cable body and lying between an outer surface of the cable and the inner cable body, a carrier strand associated with the inner cable body, the carrier strand running over the length of the inner cable body, and at least one information carrier unit, disposed within the outer surface of the cable, the at least one information carrier unit being adapted to be read by electromagnetic field coupling and being disposed on the carrier strand, and the carrier strand being covered over by the cable sheath.

54. Cable according to claim 53, wherein the carrier strand runs such that it wraps around the at least one conductor strand of the inner cable body.

55. Cable according to claim 54, wherein the carrier strand is formed such that it winds around the inner cable body.

56. Cable according to claim 53, wherein the carrier strand runs in the form of an interstitial cord of the inner cable body.

57. Cable according to claim 56, wherein the carrier strand lies directly on the inner cable body.

58. Cable according to claim 53, wherein the carrier strand is at least part of a separating layer between the inner cable body and the cable sheath.

59. Cable according to claim 53, wherein the carrier strand is a non-woven strip which is wound around the inner cable body over its complete area.

60. Cable according to claim 53, wherein the carrier strand lies on a separating layer between the inner cable body and the cable sheath.

61. Cable according to claim 53, wherein the information carrier unit is disposed on a side of the carrier strand that is facing away from the inner cable body and covered over directly by the cable sheath.

62. Cable according to claim 53, wherein the information carrier unit is embedded in the carrier strand.

63. Cable according to claim 53, wherein a multiplicity of information carrier units is disposed at defined regular intervals in the longitudinal direction of the cable and the defined regular intervals for the information carrier units determine a uniform distance between the information carrier units in the longitudinal direction of the cable.

64. Cable according to claim 63, wherein the information carrier units are disposed at the defined regular intervals in relation to one another in such a way that the distances between the information carrier units correspond to at least 2 times a reading/writing range of the information carrier units in the direction of each of the nearest information carrier units.

65. Cable according to claim 53, wherein the information carrier unit has at least one memory.

66. Cable according to claim 64, wherein the memory has a memory area in which items of information once written are stored such that they are write-protected.

67. Cable according to claim 64, wherein the memory has a memory area in which items of information are stored such that they are write-protected by an access code.

68. Cable according to claim 64, wherein the memory has a memory area to which information can be freely written.

69. Cable according to claim 53, wherein a multiplicity of information carrier units is provided and wherein each of the information carrier units can be individually addressed.

70. Cable according to claim 68, wherein each of the information carrier units can be individually addressed by an access code.

71. Cable according to claim 53, wherein the at least one information carrier unit of the cable picks up measured values of an associated sensor.

72. Cable according to claim 71, wherein the sensor picks up at least one of the state variables such as radiation, temperature, tension, pressure, elongation or moisture.
